(19) United States
(12) Patent Application Publication
(10) Pub. No.: US 2004/0153216 A1
(43) Pub. Date: Aug. 5, 2004

(54) Method for estimating a vehicle's velocity

(75) Inventor: Hualin Tan, Canton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/354,381

(22) Filed: Jan. 30, 2003

(51) Int. Cl. G06F 19/00

(52) U.S. Cl. 701/1; 701/70; 702/145

(57) ABSTRACT

A method for estimating velocities of a vehicle, is disclosed and claimed. The method includes monitoring a plurality of sensors having sensor output of vehicle motion with respect to a road surface. The method includes compensating the plurality of sensor signals by a predetermined amount, calculating the velocity by gain scheduled Kalman filtering and numerical integration, and outputting the calculated vehicle velocity to the vehicle control system.

### TECHNICAL FIELD

The present invention relates to systems and methods for obtaining a vehicle's velocity for use in vehicle dynamic control systems. Particularly, this invention relates to a system for estimating a vehicle's longitudinal and lateral velocities using information available from various vehicle sensors.

### BACKGROUND

In a conventional vehicle control system, dynamic signals indicative of a vehicle's motion are necessary for system operation. While some of the signals such as wheel speeds, yaw rate, longitudinal and lateral accelerations may be obtained by production sensors, other signals such as longitudinal and lateral velocities are not available because a vehicle velocity sensor is expensive and is not suitable for production. Longitudinal and lateral velocities have to be obtained from various estimation methods.

For example, prior art velocity estimation methods utilize acceleration, wheel speed, and yaw rate sensors, and the dynamic relationship between vehicle velocity and the measured signals are developed to produce estimations of vehicle velocities. One method utilized is Kalman filtering as disclosed in KALMAN FILTERING, THEORY AND PRACTICE, 2^{ND} EDITION, MS Grewal & AP Andrews, John Wily & Sons, Inc., 2001, incorporated herein by reference. Kalman filtering is a linear technique and, thus, the inherent nonlinearities associated with vehicle dynamics is typically ignored. Other estimation methods depend heavily on the accuracy of the vehicle tire dynamics model, as well as the estimation of road/tire friction coefficients. Thus, the computing power required to perform these calculations quickly exceeds that of a normal vehicle electronic control unit. Also, most prior art estimation methods utilize vehicle dynamic models that highly depend on vehicle parameters such as vehicle mass and tire corner stiffness, but did not address the impact of variations of these parameters on the estimations.

Therefore, there is a need for a new and improved system and method for estimating vehicle velocity. The new and improved method and system should overcome the problems associated with model nonlinearity, parameter variation, and measurement noise.

### SUMMARY

In an aspect of the present invention, a good estimation of vehicle velocity is achieved in both linear and nonlinear ranges of the vehicle's motion by using the vehicle's kinematical property to derive a vehicle dynamic model for state estimator design. This model is classified as a linear parameter varying (LPV) system where new techniques developed for this class of systems can be exploited. For a reference on LPV systems and closely related concepts regarding gain scheduling, see “RESEARCH ON GAIN SCHEDULING”, Automatica, Vol. 36, No. 9, Pages 1401-1425, 2000, and LINEAR PARAMETER VARYING CONTROLLER FOR AUTOMATED LANE GUIDANCE: EXPERIMENTAL STUDY ON TRACTOR-TRAILERS, P. Hingwe, et al., IEEE Transactions on Control Systems Technology, November 2002. Since the proposed LPV state estimator is independent of the vehicle's parameters, the velocity estimation is robust against parameter variations in vehicle mass, location of center of gravity, moment of inertia about the vertical axis, and tire cornering stiffness.

In an embodiment of the present invention, the impact on estimation accuracy from the measurement noise is reduced by applying Kalman filtering to the LPV system model. Statistical variables of the input signals (longitudinal and lateral accelerations) and output measurement signal (vehicle longitudinal speed calculated from wheel speed signals) can be determined by either experimental data or an empirical formula. Fuzzy logic technology can also be used to obtain more conclusive data on the statistics of the noise variables.

These and other aspects and advantages of the present invention will become apparent upon reading the following detailed description of the invention in combination with the accompanying drawings.

### BRIEF DESCRIPTION OF THE FIGURES

FIG. 1 is a schematic illustration of a vehicle having a control system which involves a method for estimating vehicle velocity and is implemented by an electronic control unit (ECU), in accordance with the present invention;

FIG. 2 is a block diagram illustrating the flow of sensor signal information for estimating vehicle velocity, in accordance with the present invention;

FIG. 3 is a flow chart illustrating the method for estimating vehicle velocity, in accordance with the present invention, and

FIG. 4 is a flow chart describing the process of calculating scheduled Kalman filter gains in FIG. 3, in accordance with the present invention.

### DETAILED DESCRIPTION

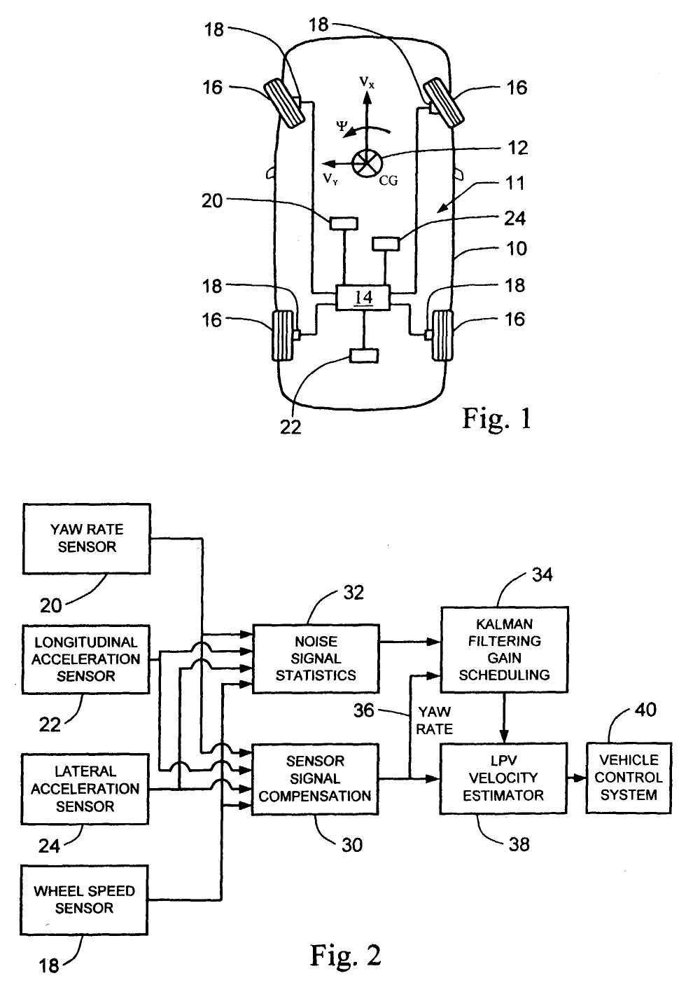

Referring now to FIG. 1, a schematic diagram of a vehicle 10 having an electronic control system 11 is illustrated in accordance with the present invention. Vehicle 10 has a center of gravity (CG) 12, and when in motion has a yaw rate indicated by the letter ψ, a longitudinal velocity indicated by arrow Vx and a lateral velocity indicated by arrow Vy. Longitudinal velocity Vx is a measure of the forwarded velocity of the vehicle. Lateral velocity Vy is a measure of the side motion of the vehicle. Yaw rate ψ is a measure of the rate of rotation of the vehicle about a vertical axis. The electronic control system 11 of vehicle 10 includes an electronic control unit (ECU) 14 for dynamically determining an operating state of motor vehicle 10, in accordance with the present invention. Generally, vehicle 10 includes at least four road wheels 16. As conventionally known, two of the road wheels rotate about a vertical axis enabling the vehicle to turn.

System 11 generally includes wheel speed sensors 18, yaw rate sensor 20, a longitudinal acceleration sensor 22 and a lateral acceleration sensor 24. Further, ECU 14 of system 11 includes a processor and an electronic memory such as RAM, ROM and/or SDRAM for storing software or program code and then executing the code to carry out various system functions. For example, system 11 may be a vehicle stability control system that requires an estimation of vehicle velocity to carry out various system functions.

Referring now to FIG. 2, a block diagram illustrating signal flow in system 11 is shown, in accordance with the present invention. As shown in FIG. 2, the various vehicle sensors: yaw rate 20, longitudinal acceleration 22, lateral acceleration 24, and wheel speed sensors 18 provide sensor output signals to a sensor signal compensation block 30 and to a noise signal statistics block 32. A Kalman filtering gain scheduling block 34 is provided and receives the noise signal statistics generated by block 32, as well as a yaw rate signal 36 from sensor signal compensation block 30. The compensated sensor signals and the scheduled Kalman filtering gains are received by a vehicle estimator block 38 for determining the velocity of vehicle 10. The estimated vehicle velocity determined at block 38 is then transmitted to the vehicle control system (i.e., system 11) represented, by block 40.

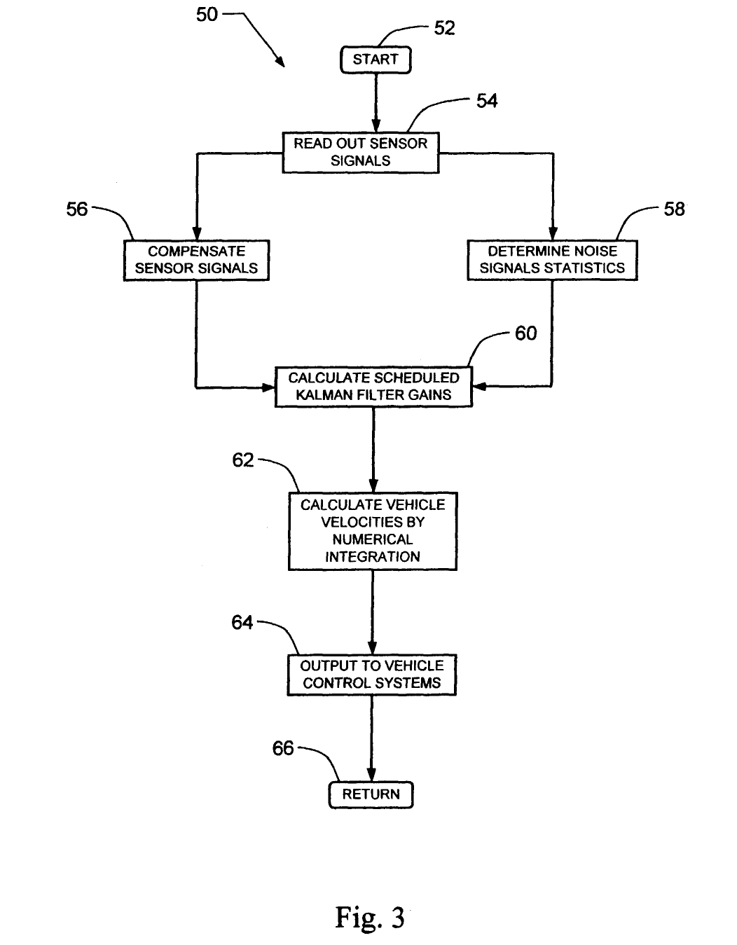

With reference to FIG. 3, a flow chart summarizing the method for estimating velocities of vehicle 10 is illustrated, in accordance with the present invention. The method 50 is initiated at block 52. The various vehicle sensors: yaw rate 20, longitudinal acceleration 22, lateral acceleration 24, and wheel speed 18 are read, as represented by block 54. The sensor signals are then compensated, or adjusted at block 56.

The compensation involves correcting the electric offsets in the signals along with eliminating noise in the signals by performing preliminary filtering. Compensation of the signals is important in providing accurate vehicle sensor signals. Accurate sensor signals leads to a more reliable vehicle velocity estimation. Many sensor compensation methods are known and available. For example, the sensor signal compensation methods disclosed in U.S. Pat. Nos. 5,742,918 and 5,809,434 may be employed for this purpose, and are incorporated herein by reference.

The application of Kalman filtering techniques requires modeling of the noise signals for the input as well as output signals. The input noise signals in the present case are the longitudinal and lateral acceleration noise signals Nx and Ny, respectively, while the output measurement noise signal is Nz, which is related to the vehicle speed calculated from wheel speed sensor measurements. Block 58 indicates the necessary computations for obtaining the statistics (the covariance) of the noise signals Nx, Ny, and Nz. Experimental data from vehicle field tests may be used to acquire the covariance of those noise signals. There are also other methods to determine the covariance matrices using limited experimental data together with knowledge of vehicle dynamics. For example, if the output measurement is a signal computed from a typical wheel speed sensor, the noise-to-signal ratio is higher at low speed, thus a corresponding covariance matrix will have larger values when vehicle speed is low, and smaller values when the vehicle speed is high. Those skilled in the art could make membership functions representing low, medium, and high covariance values and apply traditional fuzzy logic to generate the covariance matrix according to the vehicle's dynamic conditions. Fuzzy logic techniques that may be applied for this purpose are disclosed in UNCERTAIN RULE-BASED FUZZY LOGIC SYSTEMS: INTRODUCTION AND NEW DIRECTIONS, Jerry M. Mendel, Prentice Hall, 2000, and is incorporated herein by reference.

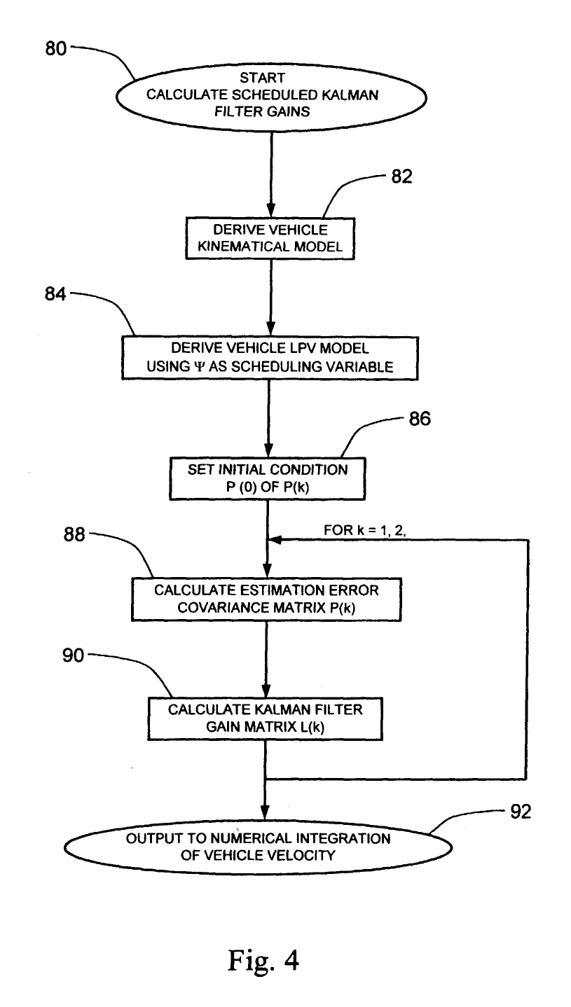

At block 60 the scheduled Kalman filter gains are calculated. For explanatory purposes, FIG. 4 is provided to describe the process by which the scheduled Kalman filter gains are obtained. The process is initiated at block 80.

The kinematical model of the vehicle's longitudinal and lateral dynamics is derived at block 82. Thus, the dynamic characteristics or properties of vehicle 10 may be described by the following equations:

$$\begin{matrix}[ \begin{matrix}\frac{ⅆ {V}_{x}}{ⅆ t} \\ \frac{ⅆ {V}_{y}}{ⅆ t}\end{matrix} ] = [ \begin{matrix}0 & Ψ \\ - Ψ & 0\end{matrix} ] [ \begin{matrix}{V}_{x} \\ {V}_{y}\end{matrix} ] + [ \begin{matrix}{A}_{x} \\ {A}_{y}\end{matrix} ] + [ \begin{matrix}{N}_{x} \\ {N}_{y}\end{matrix} ] & ( 1 ) \\ {Z}_{m} = [ \begin{matrix}1 & 0\end{matrix} ] [ \begin{matrix}{V}_{x} \\ {V}_{y}\end{matrix} ] + {N}_{z} & ( 2 )\end{matrix}$$

where:

Vₓ=longitudinal velocity;

V_{y}=lateral velocity;

Aₓ=longitudinal acceleration;

A_{y}=lateral acceleration;

ψ=yaw rate;

Zₘ=signal calculated from sensor signals and used as VX Measurement;

Nₓ=white noise signal in longitudinal velocity equation with covariance Rₓ;

N_{y}=white noise signal in lateral velocity equation with covariance R_{y}; and

N_{z}=white noise signal in measurement equation with covariance R_{z}.

Equations (1) and (2) above describe the vehicle's dynamic properties in terms of the derivatives of the longitudinal and lateral vehicle velocities. At block 84, a discrete-time, linear-parameter-varying (LPV) model based on these equations is derived. To derive the LPV model, it is assumed that the yaw rate signal ψ is a “varying parameter” or a “scheduling variable”, as further described in KALMAN FILTERING, THEORY AND PRACTICE, 2^{ND} EDITION, MS Grewal & AP Andrews, John Wily & Sons, Inc., 2001, incorporated herein by reference, and the magnitude of ψT (where T is the sampling time) is very small (usually within 1 degree). Thus, discretizing the continuous equations (1) and (2) the discrete-time LPV model is derived and written as the following difference equations:

$$\begin{matrix}[ \begin{matrix}{V}_{x} ( k + 1 ) \\ {V}_{y} ( k + 1 )\end{matrix} ] = A ( k ) [ \begin{matrix}{V}_{x} ( k ) \\ {V}_{y} ( k )\end{matrix} ] + B ( k ) [ \begin{matrix}{A}_{x} ( k ) \\ {A}_{y} ( k )\end{matrix} ] + H ( k ) [ \begin{matrix}{N}_{x} ( k ) \\ {N}_{y} ( k )\end{matrix} ] & ( 3 ) \\ \begin{matrix}{Z}_{m} ( k ) = C ( k ) [ \begin{matrix}{V}_{x} ( k ) \\ {V}_{y} ( k )\end{matrix} ] + {N}_{z} ( k ) \\ where \text{:} \\ A ( k ) = [ \begin{matrix}1 & Ψ T \\ - Ψ T & 1\end{matrix} ] , B ( k ) = H ( k ) = T [ \begin{matrix}1 & 0 \\ 0 & 1\end{matrix} ] and C ( k ) = [ \begin{matrix}1 & 0 ]\end{matrix}\end{matrix} & ( 4 )\end{matrix}$$

Based on the dynamic model described by equations (3) and (4), it follows that the calculation of the 2-by-1 time-varying, optimizing Kalman filtering gain L(k) and the 2-by-2, time-varying, estimation error covariance matrix P(k) may be determined, as shown below. The initial value of P(k) is set to P(0), at block 86. Again, P(0) is usually determined from testing data. Then, L(0) can be calculated by the following equation with k=0:

L(k)=P(k)C^{t}[CP(k)C^{t}+R_{z}]⁻¹ (5)

With both P(0) and L(0) known, P(1) can be obtained from the equation with k=0:

$$P ( k + 1 ) = A [ l - L ( k ) C ] P ( k ) {A}^{T} + [ \begin{matrix}{R}_{x} & 0 \\ 0 & {R}_{y}\end{matrix} ] \qquad ( 6 )$$

Now that P(1) is known, the above sequence can be repeated for iterative calculations of both L(k) and P(k) for any k=0,1,2, . . . as represented by blocks 88 and 90. At block 92, the results of these calculations are forwarded to block 62 of FIG. 3, where numerical integration is performed.

Those skilled in the art will appreciate that the parameters P(0), Rx, Ry and Rz may be adjusted according to the vehicle attributes, sensor specifications, and vehicle dynamic status to achieve the best vehicle velocities estimation results.

Referring again to FIG. 3, the Kalman filter gain L(k) is used in the following equations of Kalman filtering for the LPV system of the present invention to obtain the vehicle velocity estimates Vₓ(k) and V_{y}(k):

$$\begin{matrix}[ \begin{matrix}{V}_{x} ( k + 1 ) \\ {V}_{y} ( k + 1 )\end{matrix} ] = [ A - L ( k + 1 ) CA ] [ \begin{matrix}{V}_{x} ( k ) \\ {V}_{y} ( k )\end{matrix} ] + \\ [ B - L ( k + 1 ) CB ] [ \begin{matrix}{A}_{x} ( k ) \\ {A}_{y} ( k )\end{matrix} ] + \\ L ( k + 1 ) {Z}_{m} ( k + 1 )\end{matrix}$$

Here again, the velocity estimates Vₓ(k) and V_{y}(k) are calculated iteratively beginning with initial conditions Vₓ(0) and V_{y}(0).

At block 64, the vehicle velocity is communicated to the vehicle control system, such as a vehicle stability control system. Finally, at block 66, the method returns to block 52 and the process repeats itself.

Furthermore, the estimated vehicle velocities may be used by vehicle control systems such as a Traction Control (TC) system, an Electronic Stability Program (ESP) system, and many other systems to improve the performance, handling, safety, and comfort of a motor vehicle.

As any person skilled in the art of systems and methods for estimating a vehicle's velocity for use in vehicle control systems will recognize from the previous detailed description and from the figures and claims, modifications and changes can be made to the preferred embodiments of the invention without departing from the scope of this invention defined in the following claims.

1. A method for estimating a velocity of a vehicle, the method comprising:
monitoring a plurality of sensors having a plurality of sensor outputs indicative of vehicle motion with respect to a road surface;
compensating the plurality of sensor output signals by a predetermined amount;
calculating the velocity of the vehicle by numerical integration; and
outputting the calculated vehicle velocity to a vehicle control system.

2. The method of claim 1, wherein compensating the plurality of sensor signals further comprises determining a noise signal present in the plurality of sensor signals.

3. The method of claim 1, wherein calculating the velocity of the vehicle further comprises determining a plurality of Kalman filter gains.

4. The method of claim 1, wherein monitoring a plurality of sensors further comprises monitoring a yaw rate sensor.

5. The method of claim 1, wherein monitoring a plurality of sensors further comprises mounting a longitudinal acceleration sensor.

6. The method of claim 1, wherein monitoring a plurality of sensors further comprises monitoring a lateral acceleration sensor.

7. The method of claim 1, wherein monitoring a plurality of sensors further comprises monitoring a wheel speed sensor.

8. The method of claim 1 further comprises developing a dynamic model of the vehicle.

9. A method for estimating a velocity of a vehicle, the method comprising:
monitoring a plurality of sensors having a plurality of sensor outputs indicative of vehicle motion with respect to a road surface;
compensating the plurality of sensor output signals by a predetermined amount;
determining scheduled Kalman filter gains;
calculating the velocity of the vehicle using the determined Kalman filter gains and numerical integration; and
outputting the calculated vehicle velocity to a vehicle control system.

10. The method of claim 9, wherein compensating the plurality of sensor signals further comprises determining a noise signal present in the plurality of sensor signals.

11. The method of claim 9, wherein monitoring a plurality of sensors further comprises monitoring a yaw rate sensor.

12. The method of claim 9, wherein monitoring a plurality of sensors further comprises mounting a longitudinal acceleration sensor.

13. The method of claim 9, wherein monitoring a plurality of sensors further comprises monitoring a lateral acceleration sensor.

14. The method of claim 9, wherein monitoring a plurality of sensors further comprises monitoring a wheel speed sensor.

15. The method of claim 9 further comprises developing a dynamic model of the vehicle.
